(19) United States
(12) Patent Application Publication
(10) Pub. No.: US 2021/0116468 A1
(43) Pub. Date: Apr. 22, 2021

(54) ANALYSIS SYSTEM

(71) Applicant: SHIMADZU CORPORATION, Kyoto-shi, Kyoto (JP)

(72) Inventor: Shinji SUGIMOTO, Kyoto-shi, Kyoto (JP)

(73) Assignee: SHIMADZU CORPORATION, Kyoto-shi, Kyoto (JP)

(21) Appl. No.: 17/050,022

(22) PCT Filed: May 24, 2018
(86) PCT No.: PCT/JP2018/019975

§ 371 Date: Oct. 23, 2020

(51) Int. Cl. G01N 35/00; G06F 3/16

(52) U.S. Cl. CPC G01N 35/00722; G01N 2035/00851; G06F 3/16

(57) ABSTRACT

A user utters a voice containing a specific keyword according to the purpose. A voice recognition unit (152) performs verbalization processing on the voice input via a voice input unit (151) and extracts a keyword. A control information selection unit (155) refers to a control information DB (156), acquires control information corresponding to the keyword, and sends it to a data processing unit (120). The data processing unit (120) executes, for example, peak waveform processing in which parameters are changed, according to the command associated with the control information. In this way, various operations that were conventionally required to be performed by an operation unit (140) such as a keyboard or a mouse, such as a change of various parameters and conditions during data processing and a change of the data to be processed, can be performed by the voice. As a result, even infrequently used functions can be easily used, and even beginners can easily operate the functions.

### TECHNICAL FIELD

The present invention relates to an analysis system including an analysis device for instrument analysis such as a liquid chromatograph (LC), a gas chromatograph (GC), a liquid chromatograph mass spectrometer (LC-MS), or a gas chromatograph mass spectrometer (GC-MS).

### BACKGROUND ART

In recent years, the purpose of instrumental analysis using an analysis device such as an LC-MS or a GC-MS has become diversified, and accordingly analysis methods have become diversified and complicated. This leads to a complication of, in addition to an analysis device itself for collecting data, software for processing data collected by the analysis device on a computer (see, for example, Non Patent Literature 1). Hereinafter, in the present description, “software for processing data collected by an analysis device on a computer” may be simply referred to as “software” or “data processing software”.

Conventionally, analysis work using an analysis device as mentioned above is generally performed by an engineer having specialized knowledge or a researcher of a university or a research institution. However, recently, the number of contract analysis institutions (companies) that specialize in analysis work is increasing, and in such institutions, operators who have little expertise in analysis are involved in analytical work more often in order to reduce analysis costs, to improve throughput, or for similar purposes. For these reasons, for analysis devices and data processing software, there is a growing demand for simplicity of operation that even beginners can easily handle.

That is, while analysis devices and data processing software are becoming more sophisticated and complicated, operation of such devices and software is required to be simpler.

In order to meet such demands, various measures have been taken to improve operability even in conventional analysis devices and data processing software. For example, in general, in software as described above, accessibility of every function is designed to depend on the frequency of use, i.e. frequently used functions are designed to be accessed with relatively less effort (that is, to be ready for use) than infrequently used functions.

However, in software having a large number of functions, it is difficult to determine the operation procedure so as to realize the optimum operability according to the frequency of use for all the functions. Therefore, it is unavoidable that functions with poor operability, which, for example, need a plurality of click operations with a menu search or a selection operation by, are included even for such functions that the frequency of use is relatively high. As a result, it is often difficult for an inexperienced operator to make the desired function available. On the other hand, even an operator who is proficient in operation may be forced to perform multiple click operations frequently before the target function can be used, resulting in poor work efficiency and a decrease in throughput.

In addition, the conventional analysis system has the following problems.

In general, in instrumental analysis using LC, GC, or the like, it is often necessary to perform work such as pretreatment in order to prepare a sample to be analyzed. In the field where efficiency is particularly important, such as in a contract analysis institution, an operator often performs sample preparation work in parallel with analysis using an analysis device. Therefore, in order to perform the work efficiently, it is necessary for the operator to check whether or not there is an available analysis device or whether or not the analysis device is in a state where it can be used for analysis immediately, during the sample preparation work.

However, the sample preparation work is performed in a compartment equipped with dedicated draft equipment, which is often located remote from analysis devices and computers for the analysis devices. In addition, during such work, the operator generally wears special clothes and gloves for chemical handling work. Therefore, in order for the operator to operate an analysis device or software and check the status of the analysis device, the sample preparation work must be temporarily interrupted, and a wasteful time is likely to be caused in the work.

### CITATION LIST

### Non Patent Literature

Non Patent Literature 1: “Lab Solutions Insight GC/MS & LC/MS Multi-Sample Quantification Support Software LabSolutions Insight”, [Searched May 16, 2018], Shimadzu Corporation, Internet <URL: https://www.an.shimadzu.co.jp/data-net/lab solutions/insight/index.htm>

### SUMMARY OF INVENTION

### Technical Problem

The present invention has been made to solve the above problems. A first object of the present invention is to provide an analysis system that has various and complicated functions but can be operated efficiently without any mistakes even by an operator who is unskilled in operation and lacks specialized knowledge.

A second object of the present invention is to provide an analysis system in which, even in the case where an operator is in a place remote from an analysis device and a computer that controls the analysis device, or in the case where an operator cannot immediately operate an analysis device or a computer, various checks such as operating status of the analysis device can be performed easily and without wasting time.

### Solution to Problem

A first aspect of the present invention made to achieve the first object is characterized in that an analysis system, configured to perform chemical or physical analysis on a sample and to process and output collected data that is collected by the analysis, includes

a) a voice input unit configured to receive a voice uttered by a user,

b) a voice recognition processing unit configured to recognize the voice received by the voice input unit and to output control information according to the recognition result, and

c) a data processing execution unit configured to execute data processing according to the control information.

A second aspect of the present invention made to achieve the second object is characterized in that an analysis system, including one or more analysis device main units configured to perform chemical or physical analysis on a sample, and a management device connected to each of the one or more analysis device main units via a communication line and having a function of totally controlling each of the analysis device main units, includes

a) a voice input unit configured to receive a voice uttered by a user,

b) a voice recognition processing unit configured to recognize the voice received by the voice input unit and to output control information according to the recognition result,

c) an information collection unit configured to collect, from one or more analysis device main units, information indicating the status of the device according to the control information,

d) a voice synthesis unit configured to synthesize a voice corresponding to the information indicating the status of the analysis device collected by the information collection unit, and

e) a voice output unit configured to output the voice synthesized by the voice synthesis unit.

Both analysis systems of the first and second aspects according to the present invention use operations and inputs using the voice recognition technology, instead of various operations and input work conventionally performed by, for example, key operation on an operation panel, key input on a computer keyboard, click operation, drag and drop operation on a pointing device such as a mouse, and the like. Therefore, the present invention includes a voice input unit including a microphone that receives a voice uttered by a user and converts it into an electric signal, and a voice recognition processing unit that recognizes the received voice and outputs control information according to the recognition result. The voice input unit can include functions such as noise reduction for removing background noise of the input voice and echo cancellation for clarifying the voice itself.

Various well-known algorithms can be used for voice recognition in the voice recognition processing unit. Generally, input voice containing one or more specific keywords is recognized and verbalized. Then, control information for control and processing corresponding to the keywords, which are one or more words, obtained by the verbalization process is derived. It is possible to use AI (artificial intelligence) technology for this process, and it is also possible to perform a process of extracting the corresponding control information by searching a database prepared in advance.

That is, in the analysis system according to the present invention, the voice recognition processing unit may be configured to include a control information storage unit that stores a plurality of pieces of control information, and a control information selection unit that selects a corresponding piece of the control information from the control information storage unit according to the recognition result of the voice.

The control information is, for example, a command for actual processing, but it may not be a command indicating a specific processing content but may be simply a control code associated with a command. In that case, by changing the processing content of the command associated with a certain control code, it is possible to execute a different process when the same control code is output in response to the same voice.

In the first aspect of the present invention, the data processing execution unit executes data processing according to the control information output from the voice recognition processing unit. As described above, when the control information is a control code and the data processing execution unit has commands associated with various control codes, the data processing execution unit selects a command corresponding to the received control code and executes the data processing according to the command. The data processing referred to here is not only processing related to the data itself collected by the analysis, but also analysis result data obtained as a result of the processing, that is, for example, processing for creating a list or creating a graph based on the quantitative value data for each compound.

As one mode of the first aspect of the present invention,

the collected data includes data related to a plurality of analysis target components,

the voice recognition processing unit recognizes the voice of information related to at least one of the plurality of analysis target components, and

the control information selection unit may be configured to select, from the control information storage unit, control information for extracting data related to the analysis target component corresponding to the recognition result from the collected data.

In this configuration, the information related to the analysis target component recognized by the voice recognition processing unit may be any of the name of the analysis target component, the partial structure information, the mass-to-charge ratio, and the holding time.

Further, as another mode in the first aspect of the present invention,

the collected data includes a quantitative value obtained by performing predetermined data processing on the data,

the voice recognition processing unit recognizes the voice of information regarding a value range for the quantitative value, and

the control information selection unit may be configured to select, from the control information storage unit, control information for extracting data corresponding to a quantitative value within or outside the value range corresponding to the recognition result from the collected data.

In this configuration, the collected data may be chromatogram data.

As yet another mode in the first aspect of the present invention,

the data processing execution unit may be configured to execute predetermined data processing after changing a condition, a parameter, or processing target data for the predetermined data processing, according to the control information.

For example, a chromatograph such as an LC or a GC, or a mass spectrometer combined with the chromatograph such as an LC-MS or a GC-MS is often used for so-called multi-component simultaneous analysis, and in such analysis, the types of compound to be analyzed may range from tens to hundreds types. In that case, by analyzing one sample, data constituting one or more chromatograms (extracted ion chromatograms) for each of a large number of compounds are collected, so that the amount of measurement data becomes considerably large, and the amount of quantitative value data and the like obtained by processing the measurement data also increases. In addition, multi-component simultaneous analysis of a large number of samples is often performed at one time, in which case the amount of data obtained becomes even more enormous. Therefore, even if the user (operator) finds the data that should be paid attention to or really should be checked from the obtained analysis results, a complicated operation is required to select or specify the narrowing conditions for that purpose.

On the other hand, in each of the above-mentioned systems of the modes, if the data to be checked is selected from a large amount of data or the conditions for narrowing down can be input by the voice, the troublesome operation for setting the narrowing down conditions becomes unnecessary. Generally, it is necessary to select a menu in multiple stages to narrow down the data after setting detailed conditions, but by making it possible to set the narrowing conditions by voice input, the operation can be greatly simplified.

In addition, data processing software for chromatographs and mass spectrometers has many automatic processing functions. For example, in the case of quantitative analysis, an operation of cutting out a time domain in which a signal derived from the target compound is assumed to be present is performed by automatic waveform processing on the chromatogram created from the collected data. In such waveform processing, a large number of parameters are prepared so as to correspond to data of various characteristics, and the user must determine what kind of parameter is appropriate and set the parameter. Usually, setting such parameters also requires complicated operations such as multi-step menu selection.

On the other hand, in the configuration of each of the above forms, if the parameter change for data processing can be instructed by the voice, the troublesome operation for setting the parameter becomes unnecessary. In general, the parameters for such data processing are numerical information. However, the parameters need not be numerical values. It is possible to give an instruction without a concrete numerical value but with a keyword indicating a direction or a rough tendency, that is, for example, “large”, “small”, “high”, “low”, “wide”, and “narrow”, and, in actual commanding, to associate the keyword voice to a process including a numerical value as a parameter. As a result, even a user who does not fully understand the meaning of the parameter can perform the operation intuitively, and after the user checks the result of the processing according to the operation, the operator can perform additional operations if necessary. This further improves the simplicity of operation.

In the analysis system of the first aspect of the present invention, the analysis method for a sample is not limited. In view of the gist of the present invention, it is clear that the present invention is particularly useful for an analysis method in which the functions in analysis and data processing are diverse and complicated, and the amount of data obtained by the analysis and the amount of data as an analysis result are large. In this respect, the present invention is suitable for an analysis system using a GC or an LC, particularly a GC-MS or an LC-MS using a mass spectrometer as a detector.

In the first aspect of the present invention, at least a part of the functions of the voice recognition processing unit and at least a part of the functions of the data processing execution unit can be implemented by execution of software (program) installed on a computer on the computer. In that case, they are not necessarily the same computer.

The analysis system of the second aspect of the present invention includes one or more analysis device main units and a management device, each connected through a communication line. Similar to the analysis system of the first aspect, the voice input unit includes a microphone that receives a voice uttered by a user and converts it into an electric signal, and the voice recognition processing unit recognizes the received voice and outputs control information according to the recognition result. The voice input unit and the voice recognition processing unit may be a part of the analysis device main unit or the management device, respectively, or may be separate from them.

The information collection unit is a part of the management device, and collects information indicating the state of the device from one or more analysis device main units according to the control information output from the voice recognition processing unit. Specifically, it is desirable to be able to collect various types of information such as information indicating what kind of status (in operation, on standby where analysis preparation has been completed, or the like) the analysis device main unit is at that time, and information specifying an unanalyzed sample in the case of analyzing a plurality of samples sequentially, for example. When there are a plurality of analysis device main units, information indicating the status of a specific analysis device main unit may be collected, or information indicating the statuses of all the analysis device main units may be collected.

When information indicating the status of the device is collected, the voice synthesis unit synthesizes a voice corresponding to the information. Then, the voice output unit outputs the synthesized voice through a speaker or the like. Therefore, unlike the first aspect, in the second aspect of the present invention, when a user utters a voice including a specific keyword for inquiring about the status of the device that he/she wants to check through the voice input unit, in response to it, the result of the inquiry is notified by a voice through the voice output unit.

Further, the analysis system according to the second aspect of the present invention may be configured to further include a control unit that controls operation of one or more analysis device main units according to the control information.

According to this configuration, when a user wants to perform some operation on the analysis device main unit after checking the status of the analysis device main unit, the user can start the operation by a voice instruction. For example, if it is checked that a certain analysis device main unit is in a status of waiting for execution of automatic tuning, it is possible to instruct by the voice to execute automatic tuning.

The analysis system of the second aspect of the present invention can have a configuration that it is possible to inquire about not only the status of the analysis device main unit itself, but also various types of information such as data obtained by the analysis and the analysis result based on the data by the voice, and receive the response by the voice. For example, it is possible to acquire information such as whether the data collected by the analysis is normal or whether or not there is a sample presumed to be abnormal based on the analysis result, by the voice.

Further, in the second aspect of the present invention, at least a part of the function of the voice recognition processing unit, at least a part of the function of the information collection unit, and at least a part of the function of the voice synthesis unit can be implemented by executing software (program) installed on a computer on the computer. In that case, they are not necessarily the same computer.

### Advantageous Effects of Invention

According to the analysis system of the first aspect of the present invention, even if the functions are diverse or complicated, operations such as condition input and parameter setting for data processing can be simplified. As a result, for example, even a user who is unskilled in operations and lacks specialized knowledge can perform appropriate operations related to data processing and efficiently obtain accurate analysis results.

Further, according to the analysis system of the second aspect of the present invention, even if the user cannot immediately operate the analysis device or the computer, various types of information such as the operating status of the analysis device can be checked immediately and easily. As a result, it is possible to improve the throughput of the entire analysis work and reduce the analysis cost without wasting time for checking the operating status of the analysis device.

### BRIEF DESCRIPTION OF DRAWINGS

FIG. 1 is a schematic block configuration diagram of an LC-MS system according to a first exemplary embodiment of the present invention.

FIG. 2 is a schematic block configuration diagram of an LC-MS system that is a modification of the first exemplary embodiment.

FIG. 3 is a diagram showing an example of a display screen for explaining a characteristic operation in the LC-MS system of the first exemplary embodiment.

FIG. 4 is a diagram showing another example of a display screen for explaining a characteristic operation in the LC-MS system of the first exemplary embodiment.

FIG. 5 is a diagram showing another example of a display screen for explaining a characteristic operation in the LC-MS system of the first exemplary embodiment.

FIG. 6 is a diagram showing another example of a display screen for explaining a characteristic operation in the LC-MS system of the first exemplary embodiment.

FIG. 7 is a schematic block configuration diagram of an LC-MS system according to a second exemplary embodiment of the present invention.

### DESCRIPTION OF EMBODIMENTS

### First Exemplary Embodiment

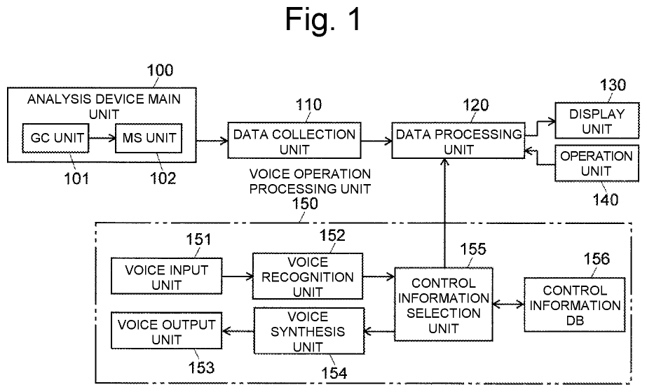

An LC-MS system according to a first exemplary embodiment of the present invention will be described with reference to the accompanying drawings. FIG. 1 is a schematic block configuration diagram of the LC-MS system of the first exemplary embodiment.

The LC-MS system includes an analysis device main unit 100 including a liquid chromatograph (LC) unit 101 and a mass spectrometry (MS) unit 102, a data collection unit 110, a data processing unit 120, a display unit 130, an operation unit 140, and a voice operation processing unit 150.

The voice operation processing unit 150 includes, as functional blocks, a voice input unit 151 including a microphone, a voice recognition unit 152, a voice output unit 153 including a speaker, a voice synthesis unit 154, a control information selection unit 155, and a control information database (DB) 156.

In the LC-MS system, LC/MS analysis is performed on a liquid sample in the analysis device main unit 100, and, for example, data constituting an extracted ion chromatogram targeting a mass-to-charge ratio corresponding to each of a large number of predetermined compounds is acquired. The data collection unit 110 includes a data storage unit, and receives and stores data obtained by the analysis device main unit 100 with the passage of time. For example, the data processing unit 120 creates an extracted ion chromatogram based on the data stored in the data collection unit 110, and obtains the area of the peak corresponding to the target compound observed on the chromatogram. Then, the concentration (content) of the target compound is calculated by applying the obtained peak area to the calibration curve prepared in advance. The concentration values obtained for respective compounds are listed and displayed on the screen of the display unit 130.

In a conventional general LC-MS system, a user sets or changes the parameters required for data processing as described above in the data processing unit 120, and selects or changes the data to be processed, by manual input or manual operation through the operation unit 140. Generally, the substance of the data collection unit 110 and the data processing unit 120 is a computer such as a personal computer or a workstation, and the data processing function is achieved by execution of dedicated software, installed on the computer, on the computer.

On the other hand, in the LC-MS system of the present embodiment, the function of the voice operation processing unit 150 is used, whereby setting or change of the parameters required for data processing or selection or change of the data to be processed can be performed by instructions or operation by the voice uttered by a user.

That is, when a user desires to perform instructions or operation by the voice, the user utters a predetermined activation keyword. In the voice operation processing unit 150, the voice input unit 151 constantly converts the voice collected by the microphone into an electric signal and inputs it to the voice recognition unit 152. In order to increase the recognition rate of the input voice, the voice input unit 151 performs voice processing such as noise reduction and echo cancellation. The voice recognition unit 152 analyzes the input voice and repeatedly determines whether or not it is an activation keyword. When the activation keyword is uttered, the voice recognition unit 152 notifies the control information selection unit 155 to that effect to activate the control information selection unit 155. Here, the voice recognition algorithm in the voice recognition unit 152 is not particularly limited, and a well-known algorithm can be appropriately adopted.

When the control information selection unit 155 is activated according to the activation keyword, that is, when the voice operation becomes substantially available, the voice synthesis unit 154 synthesizes a voice to notify the fact, and the voice can be output to the user from the voice output unit 153.

After the user uttered an activation keyword to shift the voice operation processing unit 150 to an operable state, the user utters a voice including one or a plurality of predetermined keywords according to the content of the instruction or operation. The voice recognition unit 152 analyzes the voice input through the voice input unit 151 and performs verbalization processing to extract one or more keywords (words). Upon receiving the one or more keywords, the control information selection unit 155 refers to the control information database 156 and searches for control information corresponding to the keywords. For this search, the control information database 156 has a database in which keyword information and control information are associated with each other.

The control information is a kind of command itself related to data processing or a control code corresponding to the command. When the control information selection unit 155 finds the corresponding control information, the control information selection unit 155 sends the control information to the data processing unit 120. Further, the voice synthesis unit 154 that has received an instruction from the control information selection unit 155 synthesizes a voice indicating execution of the processing corresponding to the found control information, and outputs the voice to the voice output unit 153. As a result, the user can confirm that his/her instruction has been properly accepted.

On the other hand, if corresponding control information is not found, the voice uttered by the user may be inappropriate (keywords are not included) or proper voice recognition may not be performed. Therefore, the voice synthesis unit 154 that has received the instruction from the control information selection unit 155 synthesizes a voice prompting the user to issue a voice instruction again, and the voice output unit 153 outputs the voice. This allows the user to confirm that his or her instruction has not been properly accepted.

The data processing unit 120 that has received the control information from the control information selection unit 155 executes data processing according to the control information. For example, when the control information is a command, the data processing unit 120 executes the process corresponding to the command as it is. Meanwhile, when the control information is a control code associated with the command as described above, the data processing unit 120 acquires the command corresponding to the received control code based on the correspondence table between the control code and the command, and executes the process corresponding to the command. In this way, in the LC-MS system of the present embodiment, instead of the manual operation or input via the operation unit 140, data processing according to the operation or input by the voice or the instruction by the voice is performed.

Next, a specific example of processing will be described.

### Example of Changing Narrowing Conditions by Voice Instruction

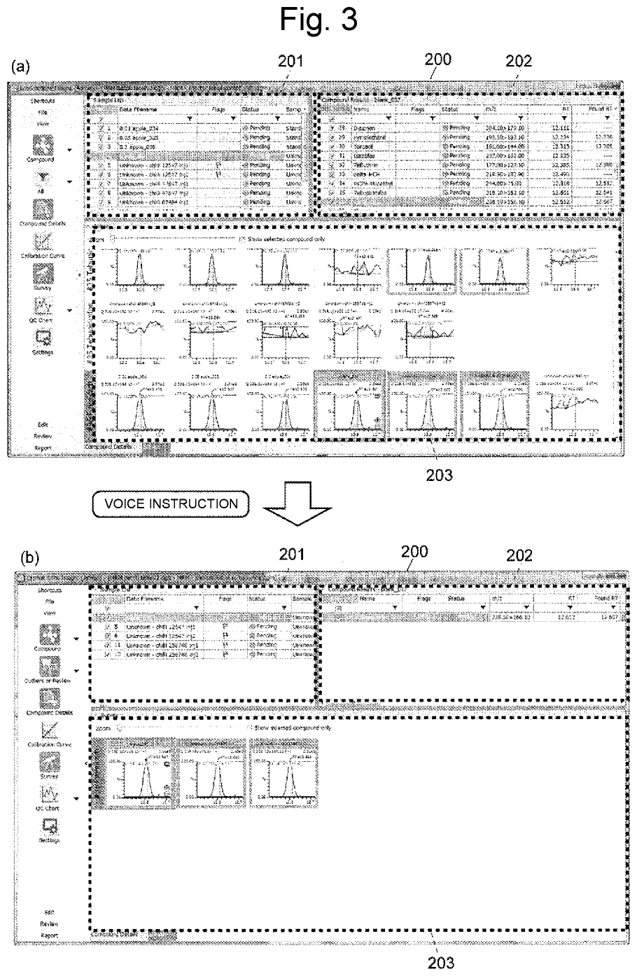

(a) of FIG. 3 is an example of a quantification result display screen in multi-component simultaneous analysis. This is an example of a display screen obtained by using, for example, the data processing software described in Non Patent Literature 1.

In a quantification result display screen 200, a sample list display area 201, a compound quantification result list display area 202, and a graph display area 203 are arranged. The sample list display area 201 shows a list including information for a plurality of samples analyzed at one time, such as a sample file name in which measurement data as a result of analyzing the sample is stored, and the sample type. The compound quantification result list display area 202 shows a compound quantification result list including the compound name, a mass-to-charge ratio (multiple reaction monitoring (MRM) transition), retention time, peak area value, and the like, based on the result of analyzing one sample on the list shown in the sample list display area 201. Further, the graph display area 203 shows a chromatogram waveform or the like used for quantification of each compound shown in the compound quantification result list.

In the case of screening such as inspection of residual pesticides contained in a sample, a large number of samples are usually analyzed at one time, and quantitative values of a large number of compounds are required for one sample. Therefore, when all of the obtained quantification results are displayed, the number of rows in the sample list and the compound quantification result list is very large as shown in (a) of FIG. 3, and the number of displayed graphs is enormous. As a result, the user may overlook or misunderstand the analysis results that the user really needs to check. Therefore, the user usually operates the operation unit 140 to narrow down the samples and compounds to be displayed to only those conforming to the predetermined conditions. However, for that purpose, it is necessary to perform menu search and selection instruction operations a plurality of times by clicking the mouse, which is considerably troublesome.

In general, when checking the screening results, it is often desired to check only results in which the quantitative value of the compound is not within the preset allowable range. In the LC-MS system of the present embodiment, in such a case, the user gives a voice instruction to “display outliers”. In the voice operation processing unit 150, the voice recognition unit 152 extracts the keywords “outliers” and “display”, and the control information selection unit 155 selects the control information corresponding to those keywords. Upon receiving such control information, the data processing unit 120 executes a process of narrowing down the samples or compounds to be displayed to only those having quantitative values determined not to be within the preset allowable range, and displays the data remaining after the narrowing down. (b) of FIG. 3 shows the quantification result display screen 200 after the narrowing down performed in this way. Since only the items and graphs that the user wants to check are displayed on the quantification result display screen 200, oversight or misunderstanding can be eliminated.

In multi-component simultaneous analysis, it is often desirable to check the quantitative result for a specific compound. In many cases, it is desired to selectively check only compounds containing a specific “group” as a partial structure. For example, when it is desired to display only compounds containing a methyl group, the user gives a voice instruction to “filter with methyl”. The voice recognition unit 152 extracts the keywords such as “methyl” and “filter”, and the control information selection unit 155 selects control information corresponding to those keywords. Upon receiving such control information, the data processing unit 120 executes a process of narrowing down the compounds to be displayed to only those containing a methyl group, and displays the data remaining after the narrowing down. The narrowing down of a specific compound containing a methyl group can be made by narrowing down the data, based on the compound name, the partial structure name, a mass-to-charge ratio, estimation from the retention time, or the like described in the sample list display area 201 or the compound quantification result list display area 202.

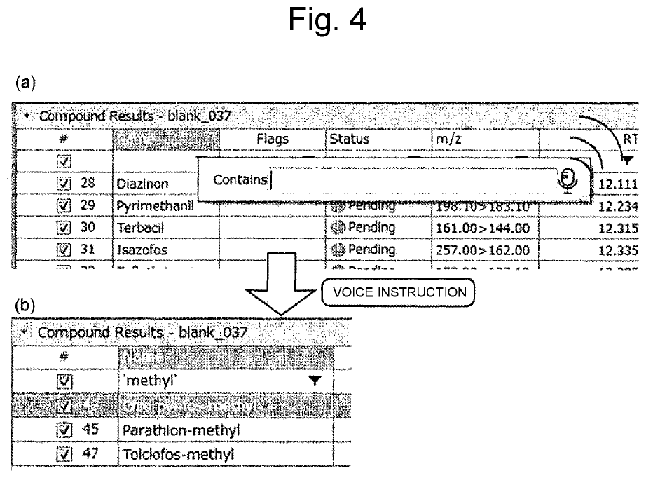

(a) of FIG. 4 is an example of the compound quantification result list before narrowing down, and (b) of FIG. 4 is an example of the compound quantification result list after narrowing down. In this way, since only the compounds that the user wants to check are shown in the list, the list is easily seen, and oversight and misunderstanding by the user can be eliminated.

As in the above example, when the user utters a specific keyword determined in advance, the entire screen to be displayed or a part of the screen can be switched to a new screen that is appropriately narrowed down. With such a function, it is possible to efficiently proceed with the analysis work by eliminating the trouble of searching the menu by a plurality of click operations, which has been necessary for the operation by the operation unit 140.

### Example of Changing Parameters for Data Processing by Voice Instruction

In the case of quantifying a compound based on a chromatogram as described above, it is usually necessary to perform work for obtaining the peak area of the peak derived from the target compound observed in the chromatogram. For that purpose, it is necessary to specify a predetermined section of the chromatogram waveform (typically, a section between the peak start point and the peak end point) and integrate the signal strength values over the predetermined section. If the peak is isolated and the baseline is nearly horizontal, an accurate peak area can be obtained by waveform processing according to the default parameters. On the other hand, if the peak is cracked, multiple peaks overlap, or the baseline is tilted, the default parameters are not appropriate and the user must change the parameters related to the waveform processing.

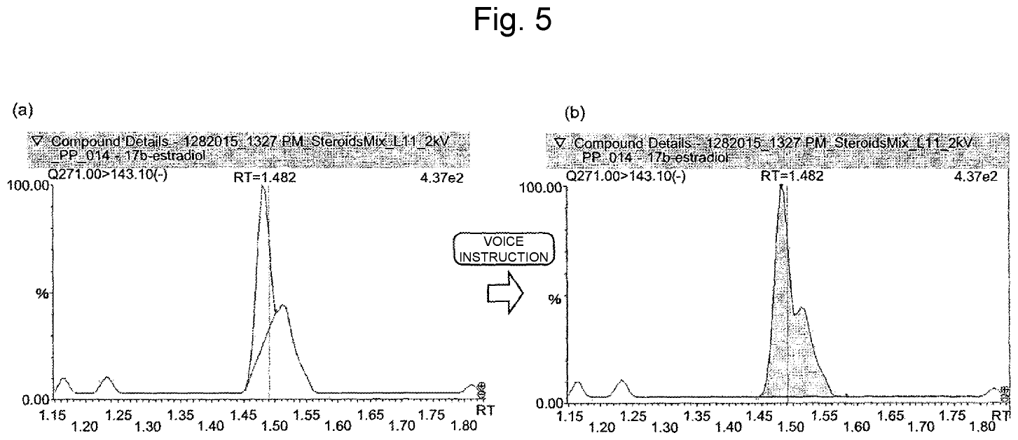

(a) of FIG. 5 shows an example of the case where the peak on the chromatogram is cracked. Such an abnormal peak shape is caused by various factors such as column dirt and deterioration, and dead volume of piping. It is difficult to distinguish between peak cracking and overlapping of multiple peaks, and when waveform processing is performed according to the default parameters, as shown in (a) of FIG. 5, it is considered that two peaks overlap. Therefore, the peak area is calculated for each peak. If it is assumed that the peak is cracked instead of a plurality of peaks overlapping each other, it is necessary for the user to perform the waveform processing after appropriately changing the waveform processing parameters.

On the other hand, in the LC-MS system of the present embodiment, the parameters of waveform processing can be changed by voice instruction. However, here, instead of instructing the numerical value of the parameter by the voice, the parameter can be changed more intuitively. Specifically, in the control information database 156, a command indicated by the control information corresponding to the keywords “peak” and “widely integrate” is defined as a process of “increasing the minimum half width by 10%”.

When it is desired to calculate the area with the entire peak estimated to have a peak crack as one peak, the user gives a voice instruction of “widely integrate the peak”. Then, the voice recognition unit 152 extracts the keywords “peak” and “widely integrate”, and the control information selection unit 155 selects the control information corresponding to those keywords. Upon receiving the control information, the data processing unit 120 executes peak detection by increasing the minimum half value width by 10%, and calculates the area of the detected peak. As a result, as shown in (b) of FIG. 5, instead of detecting the peak that is presumed to have a peak crack as two overlapping peaks, it is possible to detect it as one peak and calculate the area of the entire peak.

As another example of waveform processing, in the case of performing smoothing processing for removing high-frequency noise superimposed on a peak by a voice instruction, a command indicated by control information corresponding to the keywords “peak” and “smoothing” is defined as a process of “increasing the number of times of the smoothing process only once”, in the control information database 156.

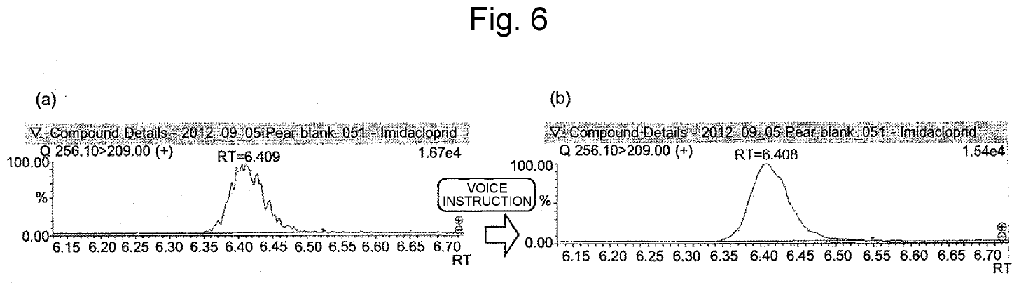

When it is desired to remove the noise superimposed on the peak, the user gives a voice instruction of “smooth the peak”. Then, the voice recognition unit 152 extracts the keywords “peak” and “smooth”, and the control information selection unit 155 selects the control information corresponding to those keywords. The data processing unit 120 that has received the control information executes a predetermined smoothing process only once. As a result, the peak waveform as shown in (a) of FIG. 6 becomes that shown in (b) of FIG. 6.

By defining a command for executing a specific process for a specific keyword via control information in this way, it is possible to intuitively change parameters or the like, without performing troublesome operations by the operation unit 140.

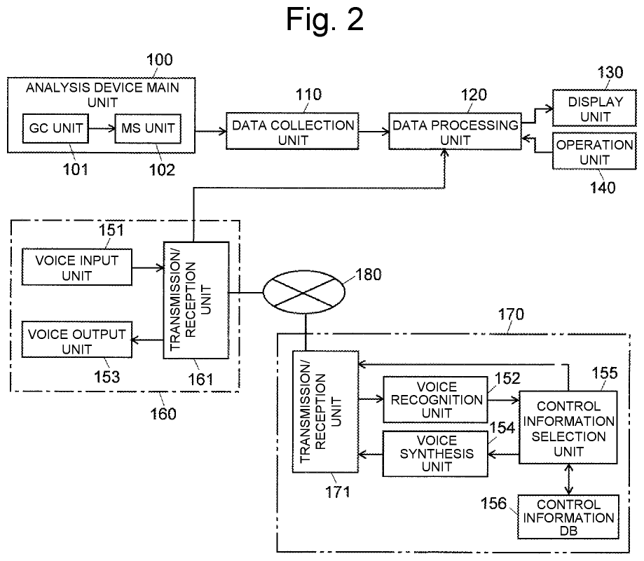

In the LC-MS system shown in FIG. 1, the voice operation processing unit 150 includes all functional blocks necessary for performing operation and control in response to the voice. The components other than the voice input unit 151 and the voice output unit 153 in the voice operation processing unit 150 can be mainly configured of a computer including a CPU, a ROM, a RAM, and the like. However, the components other than the voice input unit 151 and the voice output unit 153 can also be configured by using a cloud service provided by Google Inc. in the United States or the like via a network. FIG. 2 shows an example of a system configuration when using such a service.

In FIG. 2, the components included in the voice operation processing unit 150 in FIG. 1 are divided to a user terminal 160 in the vicinity of the user and a server 170, and the user terminal 160 and the server 170 are connected to each other via a network 180 such as the Internet. The transmission/reception units 161 and 171 are components mainly for exchanging data via the network 180, and are not essential components in the voice operation processing unit. Even in the case of using the cloud service in this way, the operation for performing data processing in response to a voice instruction is the same as described above.

### Second Exemplary Embodiment

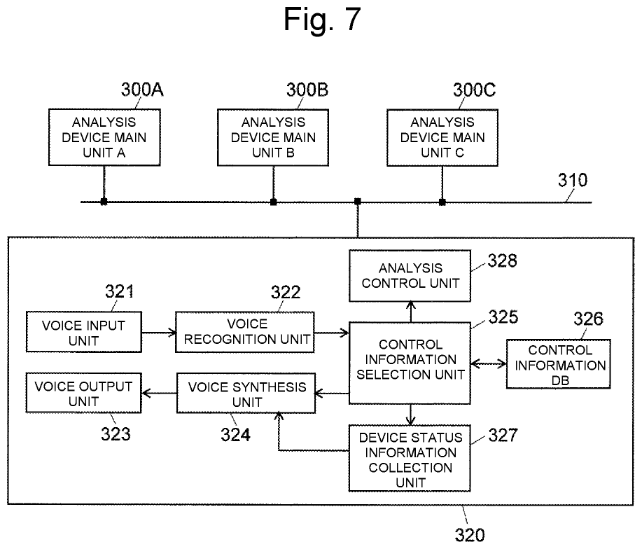

Next, an LC-MS system according to a second exemplary embodiment of the present invention will be described with reference to the accompanying drawings. FIG. 7 is a schematic block configuration diagram of the LC-MS system according to the second exemplary embodiment.

In this system, a plurality of (three in FIG. 7) analysis device main units 300A, 300B, and 300C are connected to a network 310 such as an in-house LAN. As in the first exemplary embodiment, each of the analysis device main units 300A to 300C may be an LC-MS, or they may be analysis devices of different types.

An analysis management device 320 is connected to the network 310, and the analysis management device 320 includes a voice input unit 321, a voice recognition unit 322, a voice output unit 323, a voice synthesis unit 324, a control information selection unit 325, a control information database 326, a device status information collection unit 327, and an analysis control unit 328. The voice input unit 321, the voice recognition unit 322, the voice output unit 323, the voice synthesis unit 324, the control information selection unit 325, and the control information database 326 are basically the same as the voice input unit 151, the voice recognition unit 152, the voice output unit 153, the voice synthesis unit 154, the control information selection unit 155, and the control information database 156 in the system shown in FIG. 1. However, the information content of what kind of command the control information stored in the control information database 156 corresponds to is different.

In the LC-MS system of the present embodiment, even when the analysis device main units 300A to 300C and the analysis management device 320 are installed separately, it is possible to check the operating statuses of the analysis device main units 300A to 300C of the devices or operate the analysis device main units 300A to 300C, with use of the voice operation processing function provided to the analysis management device 320.

Specifically, the control information database 326 stores the processing contents to be executed by the device status information collection unit 327 and the analysis control unit 328 in association with predetermined keywords including the identification numbers of the analysis device main units 300A to 300C. When the user wants to check the operating status of a specific analysis device main unit, he/she utters a predetermined keyword according to the content to be checked. Here, various types of information can be checked by voice operation, including those described below, for example.

(1) Check the status of the analysis device main unit (in execution of analysis, on standby where analysis can be executed immediately, in automatic tuning operation where analysis cannot be executed immediately, or the like).

(2) Check the approximate time that the analysis ends and the remaining time for the analysis device main unit in operation.

(3) Check the number of unanalyzed samples for the analysis device main unit in operation.

(4) Check the remaining amount of consumables such as the mobile phase of the LC for the analysis device main unit in operation.

(5) Check whether or not data collected by the analysis device main unit in operation contains abnormal data.

For example, when it is desired to check whether or not an analysis device main unit having the identification number No. 1 is ready for use, the user utters a voice saying “Is the No. 1 device ready for use?” The voice recognition unit 322 extracts keywords such as “No. 1 device” and “ready for use” from the voice input via the voice input unit 321, and the control information selection unit 325 selects control information corresponding to those keywords. Upon receiving the control information, the device status information collection unit 327 grasps the instruction content, accesses the No. 1 analysis device main unit 300A through the network 310, and collects status information of the device at that time. Then, the device status information collection unit 327 selects the information corresponding to the instruction content from the collected status information, and instructs the voice synthesis unit 324 to synthesize a voice corresponding to the information.

The voice synthesis unit 324 synthesizes a voice such as “No. 1 device is currently in preparation” or “No. 1 device is currently in use” in response to the instruction. Then, the voice output unit 323 responds to the user's inquiry by outputting the synthesized voice.

Further, in the LC-MS system of the present embodiment, it is possible to control part of the operation in the analysis device main units 300A to 300C by a voice instruction. For example, in the analysis device main units 300A to 300C, after completing a series of analysis and before performing the next analysis, for example, it is necessary to execute a process for eliminating the charge-up that occurred in the previous analysis, or execute an automatic tuning process in order to adjust the parameters of each part to the optimum state. Therefore, if it can be checked that there is an analysis device that is not in operation and is not ready or in preparation, the user specifies the device number and outputs an instruction by the voice to perform automatic tuning so as to make the device ready for use after a predetermined period of time elapses or at a predetermined time.

The voice recognition unit 322 extracts predetermined keywords from the input voice, and the control information selection unit 325 selects control information corresponding to those keywords. Upon receiving the control information, the analysis control unit 328 grasps the instruction content, accesses the specified analysis device main unit via the network 310, and activates the automatic tuning process so as to make the device ready for use after a predetermined period of time elapses or at a predetermined time.

As described above, in the LC-MS system of the present embodiment, when the user is away from the analysis device main units 300A and 300B, or when the user's hand is occupied and cannot perform the manual operation immediately, it is possible to acquire information about the analysis device main unit and control the operation of the analysis device main unit by performing operation and giving instructions by the voice to the analysis management device 320. As a result, it is possible to check the status of and operate the analysis device main unit in a separate room even from an environment such as a clean room where it takes time to enter and exit, so that wasteful waiting time of the analysis device main unit can be reduced and at the same time, it is possible to reduce the time required for wasteful work by the user.

In the configuration shown in FIG. 7, all the components for voice operation processing are included in the analysis management device 320. However, as explained with reference to FIG. 2, a cloud service provided via a network may be used for voice recognition and job management. In particular, in the LC-MS system of the second exemplary embodiment, it is assumed that a user who wants to perform voice operation may be away from the computer for controlling and managing the analysis device main unit. Therefore, a portable terminal such as a smartphone or a tablet PC may be equipped with the functions of the voice input unit 321 and the voice output unit 323, and a configuration of allowing the portable terminal and the management device to communicate with each other using short-range wireless communication such as Bluetooth (registered trademark) or a wireless LAN may be adoptable. As a result, the user can carry the portable terminal and check the status of the analysis device main unit from any place at any time.

It should be noted that the exemplary embodiments described above are merely examples of the present invention, and it is clear that any modifications, additions, and corrections, made as appropriate within the scope of the present invention, are included in the scope of the claims of the present application.

Specifically, the exemplary embodiments described above are examples in which the present invention is applied to a system using LC-MS, but the type of the analysis device main unit can be appropriately changed.

### REFERENCE SIGNS LIST

100, 300A, 300B, 300C . . . Analysis Device Main Unit
101 . . . Liquid Chromatograph Unit
102 . . . Mass Spectrometer
110 . . . Data Collection Unit
120 . . . Data Processing Unit
130 . . . Display Unit
140 . . . Operation Unit
150 . . . Voice Operation Processing Unit
151, 321 . . . Voice Input Unit
152, 322 . . . Voice Recognition Unit
153, 323 . . . Voice Output Unit
154, 324 . . . Voice Synthesis Unit
155, 325 . . . Control Information Selection Unit
156, 326 . . . Control Information Database
160 . . . User Terminal
161, 171 . . . Transmission/Reception Unit
170 . . . Server
180, 310 . . . Network
200 . . . Quantification Result Display Screen
201 . . . Sample List Display Area
202 . . . Compound Quantification Result List Display Area
203 . . . Graph Display Area
320 . . . Analysis Management Device
327 . . . Device Status Information Collection Unit
328 . . . Analysis Control Unit

1. An analysis system configured to perform a chemical or physical analysis on a sample and to process and output collected data that is collected by the chemical or physical analysis, the system comprising:
a) a voice input unit configured to receive a voice uttered by a user;
b) a voice recognition processing unit configured to recognize the voice received by the voice input unit and to output control information corresponding to a recognition result; and
c) a data processing execution unit configured to execute data processing according to the control information.

2. The analysis system according to claim 1, wherein
the voice recognition processing unit includes a control information storage unit configured to store a plurality of pieces of control information, and a control information selection unit configured to select a corresponding piece of the control information from the control information storage unit according to the recognition result of the voice.

3. The analysis system according to claim 2, wherein
the collected data includes data related to a plurality of analysis target components,
the voice recognition processing unit recognizes a voice of information related to at least one of the plurality of the analysis target components, and
the control information selection unit selects, from the control information storage unit, a control information for extracting data related to an analysis target component corresponding to a recognition result from the collected data.

4. The analysis system according to claim 3, wherein
the information related to the analysis target component recognized by the voice recognition processing unit is any of a name of the analysis target component, partial structure information, a mass-to-charge ratio, and retention time.

5. The analysis system according to claim 2, wherein
the collected data includes a quantitative value obtained by performing predetermined data processing on the collected data,
the voice recognition processing unit recognizes a voice of information regarding a range of values for the quantitative value, and
the control information selection unit selects, from the control information storage unit, control information for extracting data corresponding to a quantitative value within or outside the range of values corresponding to a recognition result, from the collected data.

6. The analysis system according to claim 5, wherein
the collected data is chromatogram data.

7. The analysis system according to claim 1, wherein
the data processing execution unit performs predetermined data processing after changing a condition for the predetermined data processing, a parameter, or processing target data according to the control information.

8. The analysis system according to claim 7, wherein
the voice recognition processing unit recognizes a voice of information related to a change in the predetermined data processing, and outputs control information for executing the change in the data processing corresponding to a recognition result.

9. The analysis system according to claim 8, wherein
the collected data is chromatogram data, and
the information related to the change in the data processing is related to a change in an integrated time range when a signal strength within a predetermined time range is integrated with the chromatogram data and a quantitative value is acquired based on an integrated value.

10. The analysis system according to claim 8, wherein
the collected data is chromatogram data, and
the information related to the change in the data processing is related to a change in a smoothing process for the chromatogram data.

11. The analysis system according to claim 1, wherein
as an analysis device main unit configured to execute the chemical or physical analysis on the sample, a chromatograph or a mass spectrometer is used.

12. An analysis system including one or more analysis device main units configured to perform chemical or physical analysis on a sample and a management device connected to each of the one or more analysis device main units via a communication line and having a function of totally controlling each of the analysis device main units, the system comprising:
a) a voice input unit configured to receive a voice uttered by a user,
b) a voice recognition processing unit configured to recognize the voice received by the voice input unit and to output control information according to a recognition result;
c) an information collection unit configured to collect, from one or more analysis device main units, information indicating a status of a device of the one or more analysis device main units according to the control information;
d) a voice synthesis unit configured to synthesize a voice corresponding to the information indicating the status of the device collected by the information collection unit; and
e) a voice output unit configured to output the voice synthesized by the voice synthesis unit.

13. The analysis system according to claim 12, further comprising
a control unit configured to control operation of the one or more analysis device main units according to the control information.

14. The analysis system according to claim 12, wherein
as each of the one or more analysis device main units configured to execute the chemical or physical analysis on the sample, a chromatograph or a mass spectrometer is used.
